(19) United States
(12) Patent Application Publication
(10) Pub. No.: US 2017/0038994 A1
(43) Pub. Date: Feb. 9, 2017

(54) STORAGE DEVICE AND DATA READING METHOD

(71) Applicant: Kabushiki Kaisha Toshiba, Tokyo (JP)

(72) Inventors: Masamitsu Ohhashi, Yokohama Kanagawa (JP); Takeyuki Minamimoto, Tachikawa Tokyo (JP); Masaki Saito, Yokohoma Kanagawa (JP); Taichi Ejiri, Yokohama Kanagawa (JP)

(21) Appl. No.: 14/945,138

(22) Filed: Nov. 18, 2015

Related U.S. Application Data
(60) Provisional application No. 62/201,743, filed on Aug. 6, 2015.

(51) Int. Cl. G06F 3/06; G06F 12/14

(52) U.S. Cl. CPC G06F 3/0634; G06F 3/0604; G06F 3/0622; G06F 3/0679; G06F 12/14; G06F 2212/1052

(57) ABSTRACT

According to one embodiment, a storage device, after transitioning to a read only mode, performs an authentication process of authenticating a user of the storage device once with respect to power on the storage device, and reads data from a first area according to a read request regardless of management information if the authentication process succeeds in user authentication. The read only mode is a mode in which reading data from the first area and a second area is allowed while writing data into the first and second areas is prohibited.

### CROSS-REFERENCE TO RELATED APPLICATIONS

This application is based upon and claims the benefit of priority from U.S. Provisional Application No. 62/201,743, filed on Aug. 6, 2015; the entire contents of which are incorporated herein by reference.

### FIELD

Embodiments described herein relate generally to a storage device and a data reading method.

### BACKGROUND

Among storage devices such as a solid state drive (SSD), there is one which has a function of, if detecting that a semiconductor memory such as a NAND flash has worn out, making it transition to a read only mode, in which disabling writing data into the semiconductor memory and only reading data from the semiconductor memory is allowed. When it has transitioned to the read only mode, data cannot be written into a user data area nor a system area in the storage device. Therefore, the storage device having transitioned to the read only mode writes data read from the semiconductor memory into another normally operating storage device which the system in which that storage device is provided has, so that data can continue to be used in that system without a data loss.

However, if transitioning to the read only mode, the storage device cannot write data into the system area, and hence lock setting cannot be updated, so that the prohibition of reading data from a lock set area cannot be lifted. Thus, if transitioning to the read only mode, the storage device cannot read data stored in the lock set area, so that the host cannot back up the data stored in the lock set area.

### BRIEF DESCRIPTION OF THE DRAWINGS

FIG. 1 is a block diagram showing an example configuration of a storage system according to a present embodiment;

FIG. 2 is a sequence diagram showing an example flow of access to a lock set region in a storage device according to the present embodiment;

FIG. 3 is a sequence diagram showing another example flow of access to the lock set region in the storage device according to the present embodiment; and

FIG. 4 is a flow chart showing an example flow of access to the lock set region in the storage device according to the present embodiment.

### DETAILED DESCRIPTION

According to the present embodiment, a storage device comprises a semiconductor memory and a controller. The semiconductor memory includes a first area storing data and a second area storing management information. The management information is information for prohibiting or allowing reading data from the first area. The controller controls to write and read data into and from the first area depending on the management information, after the storage device transitions to a read only mode, performs an authentication process of authenticating a user of the storage device once with respect to power on the storage device, reads data from the first area according to a read request regardless of the management information if the authentication process succeeds in user authentication, and does not read data from the first area according to the read request if the authentication process fails in the user authentication. The read only mode is a mode in which reading data from the first and second areas is allowed while writing data into the first and second areas is prohibited.

A storage system to which the storage device and data reading method according to an embodiment is applied will be described in detail below with reference to the accompanying drawings. The present invention is not limited to this embodiment.

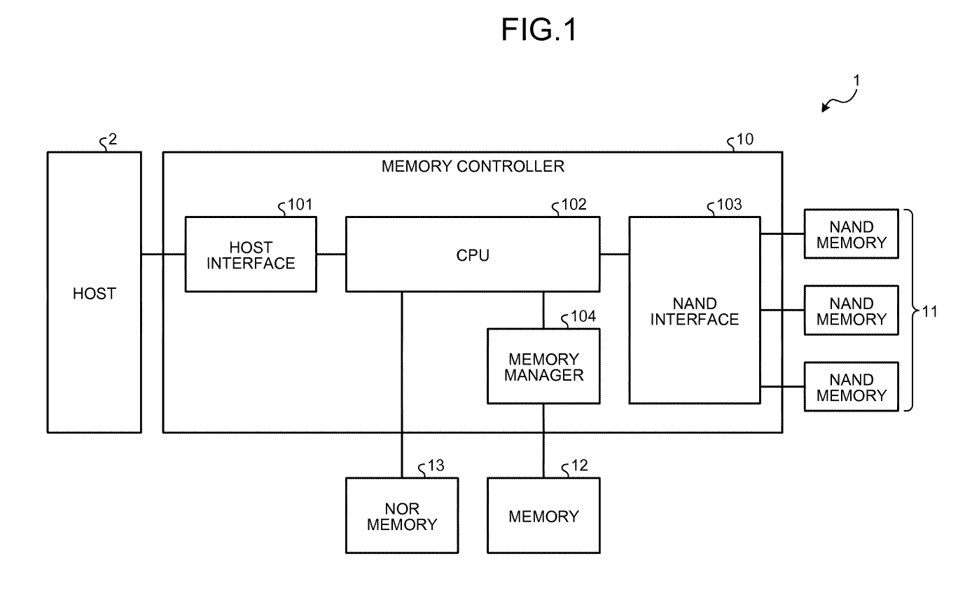

FIG. 1 is a block diagram showing an example configuration of the storage system according to the present embodiment. As shown in FIG. 1, in the storage system according to the present embodiment, a storage device 1 and a host 2 are connected via connection lines. The host 2 is constituted by, e.g., a server, a central processing unit (CPU), or the like. The storage device 1 receives various commands such as a write command or a read command from the host 2 and performs various operations according to the received commands. Here, the write command is a command that instructs the storage device to write data into a NAND memory 11, described later. The read command (an example of a read request) is a command that instructs the storage device to read data from the NAND memory 11.

The storage device 1 comprises the NAND memory 11 (an example of a semiconductor memory) constituted by a NAND flash memory, and a memory controller 10 (an example of a control unit) that performs data transfer between the host 2 and the NAND memory 11. Although in the present embodiment the storage device 1 comprises the NAND memory 11 as an example of the semiconductor memory, not being limited to this, it may comprise, e.g., a NOR flash memory as an example of the semiconductor memory.

The NAND memory 11 has a user area and a system area. The user area is an area in the NAND memory 11 to store data and to write data into according to a write command received from the host 2. In the present embodiment, the user area has a lock set region (an example of a first area). The lock set region is a region in the user area on which a lock setting is set. The lock setting (an example of management information) is a setting which prohibits or allows writing and reading data into and from the lock set region. The lock setting need only be information for prohibiting or allowing at least reading data from the lock set region. For example, the lock setting may be information for prohibiting or allowing only reading data from the lock set region.

The system area is a storage area which the memory controller 10 uses to operate. Specifically, the system area (an example of a second area) stores the lock setting. Further, the system area stores pass words used in the process of authenticating users who use the storage device 1, the number of times when data was written into the NAND memory 11 (hereinafter called the number of write times), the number of authentication try times that is the number of times when the authentication process failed in user authentication, and so on.

The memory controller 10 controls writing and reading data into and from the NAND memory 11. In the present embodiment, when the storage device 1 has not transitioned to a read only mode, the memory controller 10 writes data into the NAND memory 11 according to a write command and increments the number of write times stored in the system area. Here, the read only mode is a mode in which reading data from the NAND memory 11 (the user area and system area) is allowed while writing into the NAND memory 11 (the user area and system area) is prohibited. In the present embodiment, if the number of write times stored in the system area has reached a predetermined limit number of write times, the storage device 1 transitions to the read only mode. Thus, the NAND memory 11 can be prevented from wearing out so as not to be able to read data from, and hence data stored in the NAND memory 11 can be backed up. The predetermined limit number of write times (an example of a predetermined number of times) is the upper limit of the number of write times at which data can be normally read from the NAND memory 11, or less by a predetermined number of times than the upper limit.

When the storage device 1 has not transitioned to the read only mode, the memory controller 10 reads data from the NAND memory 11 according to a read command. In contrast, when the storage device 1 has transitioned to the read only mode, the memory controller 10 prohibits writing data into the NAND memory 11 and reads data from the NAND memory 11 according to a read command.

The memory controller 10 writes and reads data into and from the lock set region depending on the lock setting stored in the system area. Specifically, the memory controller 10 prohibits writing data into the lock set region if the lock setting is set to prohibit writing data. On the other hand, if the lock setting is set to allow writing data, the memory controller 10 writes data into the lock set region. If the lock setting is set to prohibit reading data, the memory controller 10 prohibits reading data from the lock set region. On the other hand, if the lock setting is set to allow reading data, the memory controller 10 reads data from the lock set region.

The memory controller 10 is connected to a memory 12 via connection lines. The memory 12 is constituted by, e.g., a random access memory (RAM), a dynamic random access memory (DRAM), or a static random access memory (SRAM) and is used as a storage area to temporarily store various data therein. That is, the memory 12 is a volatile semiconductor memory. Further, the memory controller 10 is connected to a NOR memory 13 (an example of a nonvolatile memory) that is a NOR flash memory via connection lines. The NOR memory 13 is a memory to which data stored in the NAND memory 10 is backed up. That is, the NOR memory 13 is a nonvolatile semiconductor memory.

The memory controller 10 comprises a host interface 101, a CPU 102, a NAND interface 103, and a memory manager 104. These blocks are connected to each other via a bus.

The CPU 102 controls the entire memory controller 10 according to firmware. The host interface 101 transmits and receives various commands and the like to and from the host 2 under the control of the CPU 102. The NAND interface 103 transmits and receives a variety of information to and from the NAND memory 11 under the control of the CPU 102. The memory manager 104 transmits and receives a variety of information to and from the memory 12 under the control of the CPU 102.

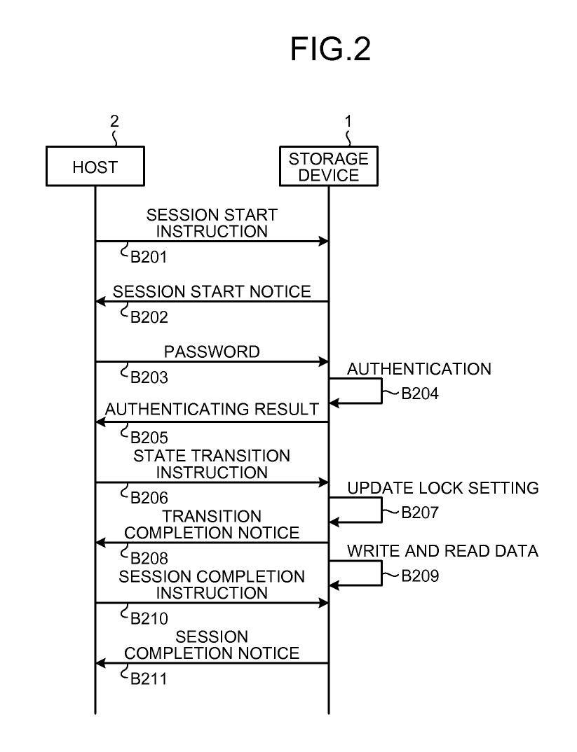

Next, access to the lock set region when the storage device 1 has not transitioned to the read only mode will be described using FIG. 2. FIG. 2 is a sequence diagram showing an example flow of access to the lock set region in the storage device according to the present embodiment.

When receiving a session start instruction instructing it to start communication from the host 2 (B201), the memory controller 10 of the storage device 1 transmits a session start notice to notify a session start to the host 2 (B202) so as to establish communication with the host 2. Then the memory controller 10 writes and reads data into and from the NAND memory 11 according to a write command and a read command received from the host 2. Note that the memory controller 10 writes and reads data into and from the lock set region depending on the lock setting stored in the system area when writing and reading data into and from the lock set region.

After communication with the storage device 1 is established, when a password is entered, the host 2 transmits the entered password to the storage device 1 to instruct it to perform the authentication process of the user who wants to use the storage device 1 (B203).

When receiving the password from the host 2, the memory controller 10 of the storage device 1 performs the authentication process of authenticating the user of the storage device 1 (B204). In the present embodiment, the memory controller 10 performs the authentication process using the password received from the host 2 and a password stored in the system area of the NAND memory 11. Then the memory controller 10 transmits the authenticating result that is the result of the authentication process to the host 2 (B205). In the present embodiment, if the authentication process succeeds in user authentication, the memory controller 10 transmits the authenticating result indicating “OK” to the host 2. On the other hand, if the authentication process fails in user authentication, the memory controller 10 transmits the authenticating result indicating “NG” to the host 2.

If the authenticating result received from the storage device 1 indicates “OK”, the host 2 transmits a state transition instruction to instruct it to transition to an unlocked state to the storage device 1 (B206). Here, the unlocked state is a state where writing and reading data into and from the lock set region are allowed. If the authenticating result received from the storage device 1 indicates “OK”, the storage device 1 may be already in the unlocked state, but also in this case, the host 2 can likewise transmit the state transition instruction to instruct it to transition to the unlocked state to the storage device 1 (B206). On the other hand, if the authenticating result received from the storage device 1 indicates “NG”, in order to allow it to continue to be in a locked state, the host 2 does not transmit the state transition instruction. Here, the locked state is a state where writing and reading data into and from the lock set region are prohibited.

If the authentication process succeeds in user authentication, and if receiving the state transition instruction from the host 2, the memory controller 10 of the storage device 1 updates the lock setting (B207). Specifically, the memory controller 10 lifts the prohibition of writing and reading data into and from the lock set region. Further, the memory controller 10 updates the lock setting to allow writing and reading data into and from the NAND memory 11 and transmits a transition completion notice to notify having transitioned to the unlocked state to the host 2 (B208).

Then the memory controller 10 writes and reads data into and from the lock set region according to a write command and a read command received from the host 2 (B209). Note that, if the authentication process fails in user authentication, the memory controller 10, without updating the lock setting, writes and reads data into and from the lock set region depending on the lock setting.

Then the host 2 transmits a session completion instruction to instruct it to finish the session to the storage device 1 in order to perform the next operation (B210). The memory controller 10 of the storage device 1 transmits a session completion notice to notify the session completion to the host 2 (B211) so as to finish communication with the host 2.

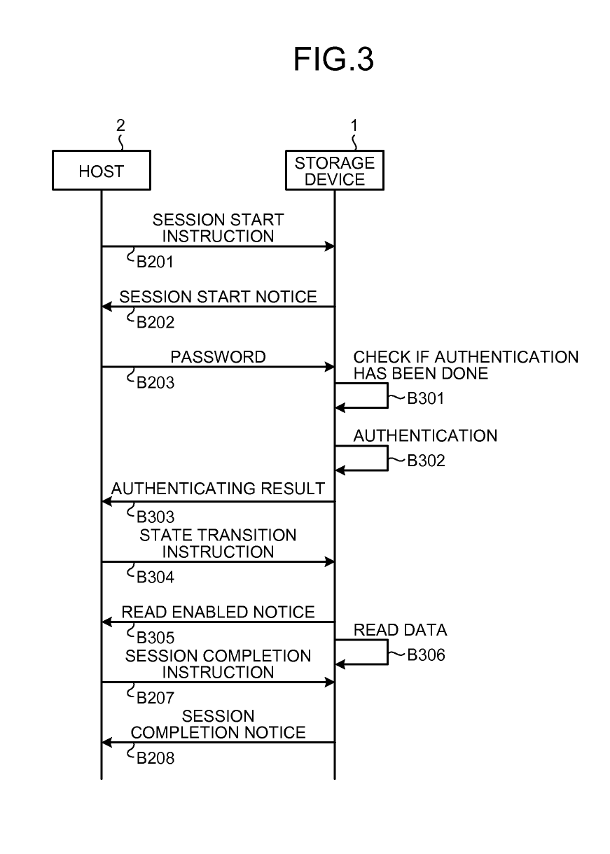

Next, access to the lock set region when the storage device 1 has transitioned to the read only mode will be described using FIG. 3. FIG. 3 is a sequence diagram showing an example flow of access to the lock set region in the storage device according to the present embodiment. In FIG. 3, the same reference numerals are used to denote the same processing as in FIG. 2.

When receiving a session start instruction instructing it to start communication from the host 2 (B201), the memory controller 10 of the storage device 1 transmits a session start notice to notify a session start to the host 2 (B202) so as to establish communication with the host 2. After communication with the storage device 1 is established, when a password is entered, the host 2 transmits the entered password to the storage device 1 to instruct it to perform the authentication process of the user who wants to use the storage device 1 (B203).

The memory controller 10 checks whether the storage device 1 is in the read only mode, and, if in the read only mode, checks whether the authentication process has been already performed in any mode. If any authentication process has been performed, then mode setting is performed in such a way as not to release the lock setting, and, if an authentication process has not yet been performed, then the process proceeds to the authentication process for the password received from the host 2 (B301). When receiving the password from the host 2, the memory controller 10, referring to a password stored in the NOR memory 13 and the password transmitted by the host 2, performs the authentication process to determine whether the password transmitted by the host 2 coincides with the password stored in the NOR memory 13 (B302). In the present embodiment, the memory controller 10 implements a measure against brute force attacks for a password received from the host 2 (an example of an external device).

In the present embodiment, after the password is inputted from the host 2, the memory controller 10 waits for a predetermined wait time (e.g., two seconds) before reading data stored in the lock set region regardless of the result of the authentication process. Thus, even if a brute force attack is performed, a password can be prevented from leaking out because with which one of multiple passwords inputted from the host 2 it succeeded or failed in user authentication cannot be identified.

Then the memory controller 10 transmits the authenticating result that is the result of the authentication process to the host 2 (B303). In the present embodiment, if the authentication process succeeds in user authentication, the memory controller 10 transmits the authenticating result indicating “OK” to the host 2. On the other hand, if the authentication process fails in user authentication, the memory controller 10 transmits the authenticating result indicating “NG” to the host 2.

If the authenticating result received from the storage device 1 indicates “OK”, the host 2 transmits the state transition instruction to instruct it to transition to the unlocked state to the storage device 1 (B304). On the other hand, if the authenticating result received from the storage device 1 indicates “NG”, in order to allow it to continue to be in the locked state, the host 2 does not transmit the state transition instruction.

If the authentication process succeeds in user authentication, and if receiving the state transition instruction from the host 2, the memory controller 10 of the storage device 1, without accessing the system area (i.e., without updating the lock setting stored in the system area), lifts the prohibition of reading from the lock set region for the memory 12 alone. Further, the memory controller 10 transmits a read enabled notice to notify that it is possible to read data from the lock set region to the host 2 (B305).

Then the memory controller 10 reads data from the lock set region according to a read command regardless of the lock setting in the system area (B306). At this time, only if it receives read commands consecutively from the host 2, the memory controller 10 reads data from the lock set region. Then the memory controller 10 prohibits reading data when a predetermined time has elapsed since it came not to receive a read command. When the storage device 1 is not in the read only mode, the memory controller 10 enables reading data from the lock set region by updating the lock setting, but, after transitioning to the read only mode, the memory controller 10 cannot update the lock setting. Accordingly, the memory controller 10 lifts the prohibition of reading from the lock set region for the memory 12 alone so as to enable reading data from the lock set region according to a read command regardless of the lock setting stored in the system area. Thus, even when the storage device 1 has transitioned to the read only mode, data can be read from the lock set region, so that data for backup can be acquired.

Then the host 2 transmits a session completion instruction to instruct it to finish the session to the storage device 1 in order to perform the next operation (B207). The memory controller 10 of the storage device 1 transmits a session completion notice to notify the session completion to the host 2 (B208) so as to finish communication with the host 2.

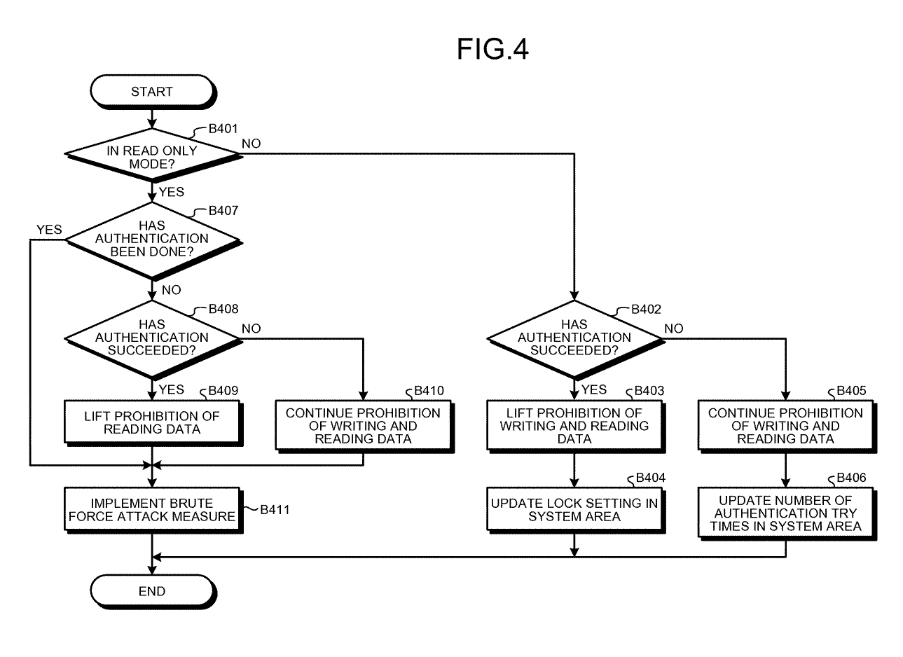

Next, access to the lock set region in the storage device 1 according to the present embodiment will be described in detail using FIG. 4. FIG. 4 is a flow chart showing an example flow of access to the lock set region in the storage device according to the present embodiment.

After communication with the host 2 is established, the memory controller 10 determines whether the storage device 1 has transitioned to the read only mode (B401). If the storage device 1 has not transitioned to the read only mode (No at B401), the memory controller 10 performs the authentication process. If the authentication process succeeds in user authentication (Yes at B402), the memory controller 10 lifts the prohibition of writing and reading data into and from the lock set region (B403) and updates the lock setting stored in the system area to allow writing and reading data into and from the lock set region (B404). Thus, the memory controller 10 can write and read data into and from the lock set region according to a write command or a read command received from the host 2.

On the other hand, if the authentication process fails in user authentication (No at B402), the memory controller 10 continues the prohibition of writing and reading data into and from the lock set region (B405) and updates (i.e., increments) the number of authentication try times stored in the system area of the NAND memory 11 (B406). Then if the number of authentication try times exceeds a predetermined number of times, the memory controller 10 prohibits updating the lock setting even if the authentication process succeeds in user authentication. Thus, when an unauthorized user enters passwords repeatedly, if the number of authentication try times exceeds the predetermined number of times, then it becomes impossible to update the lock setting, so that the unauthorized user can be prevented from updating the lock setting.

If the storage device 1 has transitioned to the read only mode (Yes at B401), the memory controller 10 determines whether the authentication process of authenticating a user of the storage device 1 has been performed since the storage device 1 was last powered on (B407). If the authentication process of authenticating a user of the storage device 1 has been performed since the storage device 1 was last powered on (Yes at B407), the memory controller 10 does not perform the authentication process of a user of the storage device 1 nor lift the prohibition of reading data from the lock set region. On the other hand, if the authentication process of authenticating a user of the storage device 1 has not been performed since the storage device 1 was last powered on (No at B407), the memory controller 10 performs the authentication process. Then, if the authentication process succeeds in user authentication (Yes at B408), the memory controller 10 lifts the prohibition of reading data from the lock set region for the memory 12 alone without accessing the system area (B409). That is, the memory controller 10 reads data from the lock set region according to a read command regardless of the lock setting.

On the other hand, if the authentication process fails in user authentication (No at B408), the memory controller 10 continues the prohibition of writing and reading data into and from the lock set region (B410), and updates the number of authentication try times stored in the NOR memory 13. That is, if the authentication process fails in user authentication (No at B408), the memory controller 10 keeps the setting for the prohibition of writing and reading data (B410) so as not to read data from the lock set region according to a read command. If the number of authentication try times stored in the NOR memory 13 exceeds a predetermined number of times, the memory controller 10 prohibits reading data from the lock set region even if the authentication process succeeds in user authentication. Thus, when an unauthorized user enters passwords repeatedly, if the number of authentication try times exceeds the predetermined number of times, then it becomes impossible to read data from the lock set region, so that the unauthorized user can be prevented from acquiring data in the lock set region.

After the authentication process is performed, the memory controller 10 implements a measure against brute force attacks (B411). In the present embodiment, after the authentication process is performed, the memory controller 10 implements the measure against brute force attacks, but not being limited to this, the measure against brute force attacks may be implemented before the authentication process is performed. In the present embodiment, the memory controller 10 performs the process of waiting for a predetermined wait time (e.g., two seconds) before reading data from the lock set region as the measure against brute force attacks. Thus, it can be prevented to steal a password taking advantage of the time difference in notifying the processing result that occurs between when succeeding in user authentication and when failing in user authentication.

According to the present embodiment, after the storage device 1 is powered on, if the storage device 1 has transitioned to the read only mode, then the memory controller 10 performs the authentication process only once, and, if succeeding in user authentication, reads data from the lock set region according to a read command regardless of the lock setting. As a result, the effect can be obtained that it is possible to read data from the lock set region, and the host 2 can acquire data for backup.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a semiconductor memory configured to include a first area storing data and a second area storing management information, the management information being information for prohibiting or allowing reading data from the first area; and
a controller configured to controls to write and read data into and from the first area depending on the management information, after the storage device transitions to a read only mode, performs an authentication process of authenticating a user of the storage device once with respect to power on the storage device, reads data from the first area according to a read request regardless of the management information if the authentication process succeeds in user authentication, and does not read data from the first area according to the read request if the authentication process fails in the user authentication, the read only mode being a mode in which reading data from the first and second areas is allowed while writing data into the first and second areas is prohibited.

2. The storage device of claim 1, wherein the storage device transitions to the read only mode if the number of times when data was written into the semiconductor memory reaches a predetermined number of times.

3. The storage device of claim 1, further comprising:
a nonvolatile memory configured to store a password to be used in the authentication process of the user of the storage device,
wherein the controller performs, in case where the storage device has transitioned to the read only mode, the authentication process of the user of the storage device using a password inputted from an external device and the stored password.

4. The storage device of claim 3, wherein the nonvolatile memory stores the number of authentication try times when the control unit failed in the authenticating the user of the storage device, and
wherein if the number of authentication try times stored in the nonvolatile memory exceeds a predetermined number of times, the controller prohibits reading data from the first area.

5. The storage device of claim 3, wherein the controller implements a measure against brute force attacks for the password inputted from the external device.

6. The storage device of claim 5, wherein the measure against brute force attacks is a process of, after the password is inputted from the external device, waiting for a predetermined wait time before reading data from the first area.

7. The storage device of claim 5, wherein the controller implements the measure against brute force attacks before or after performing the authentication process of the user of the storage device.

8. The storage device of claim 1, wherein the controller performs, in case where the storage device has not transitioned to the read only mode, the authentication process of authenticating the user of the storage device, and updates the management information to allow reading data from the first area if the authentication process succeeds in the user authentication.

9. The storage device of claim 8, wherein the semiconductor memory stores a password to be used in the authenticating the user of the storage device,
wherein the controller performs, in case where the storage device has not transitioned to the read only mode, the authentication process of authenticating the user of the storage device using a password inputted from an external device and the stored password.

10. The storage device of claim 1, wherein the semiconductor memory stores the number of authentication try times when the control unit failed in the authenticating the user of the storage device, and
wherein if the number of authentication try times stored in the semiconductor memory exceeds a predetermined number of times, the controller prohibits updating the management information.

11. A method comprising:
writing and reading data into and from a first area that a semiconductor memory provided in a storage device has depending on management information stored in the semiconductor memory, the management information being information for prohibiting or allowing reading data from the first area;
performing, after the storage device transitions to a read only mode, an authentication process of authenticating a user of the storage device once with respect to power on the storage device, the read only mode being a mode in which reading data from the first area and a second area storing the management information in the semiconductor memory is allowed while writing data into the first and second areas is prohibited;
if the authentication process succeeds in user authentication, reading data from the first area according to a read request regardless of the management information; and
if the authentication process fails in the user authentication, not reading data from the first area according to the read request.

12. The method of claim 11, wherein the storage device transitions to the read only mode if the number of times when data was written into the semiconductor memory reaches a predetermined number of times.

13. The method of claim 11, wherein the storage device further comprises a nonvolatile memory configured to store a password to be used in the authentication process of the user of the storage device,
wherein the method further comprises, performing, in case where the storage device has transitioned to the read only mode, the authentication process of the user of the storage device using a password inputted from an external device and the stored password.

14. The method of claim 13, wherein the nonvolatile memory stores the number of authentication try times when the authentication process failed in the authenticating the user of the storage device, and
wherein the method further comprises, if the number of authentication try times stored in the nonvolatile memory exceeds a predetermined number of times, prohibiting reading data from the first area.

15. The method of claim 13, further comprises implementing a measure against brute force attacks for the password inputted from the external device.

16. The method of claim 15, wherein the measure against brute force attacks is a process of, after the password is inputted from the external device, waiting for a predetermined wait time before reading data from the first area.

17. The method of claim 15, which comprises implementing the measure against brute force attacks before or after performing the authentication process of the user of the storage device.

18. The method of claim 11, which comprises, performing, in case where the storage device has not transitioned to the read only mode, the authentication process of authenticating the user of the storage device, and updating the management information to allow reading data from the first area if the authentication process succeeds in the user authentication.

19. The method of claim 18, wherein the semiconductor memory stores a password to be used in the authenticating the user of the storage device,
wherein the method comprises, performing, in case where the storage device has not transitioned to the read only mode, the authentication process of authenticating the user of the storage device using a password inputted from an external device and the stored password.

20. The method of claim 11, wherein the semiconductor memory stores the number of authentication try times when the authentication process failed in the authenticating the user of the storage device, and
wherein the method comprises, if the number of authentication try times stored in the semiconductor memory exceeds a predetermined number of times, prohibiting updating the management information.
